(19) United States
(12) Patent Application Publication
(10) Pub. No.: US 2006/0073081 A1
(43) Pub. Date: Apr. 6, 2006

(54) Analytical chip glass substrate and analytical chip

(75) Inventor: Hideo Nomoto, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Tokyo (JP)

(21) Appl. No.: 11/235,194

(22) Filed: Sep. 27, 2005

(30) Foreign Application Priority Data
Oct. 1, 2004 (JP) 2004-289782

(51) Int. Cl. G01N 1/00

(52) U.S. Cl. 422/102

(57) ABSTRACT

A analytical chip glass substrate which is a soda lime silica glass sheet containing at most 0.1 mass % of Fe, in terms of Fe₂O₃.

The present invention relates to a glass substrate suitable to make a biochip by arranging and immobilizing trace amounts of biological high-molecular-weight oligomers such as DNA, RNA, sugar chains and proteins corresponding to hundreds to tens thousands of genes. Further, the present invention relates also to a glass substrate suitable to make microfluidics which are useful mainly for chemical analyses or chemical reactions and whereby fine flow paths having a width of from a few hundreds nm to a few hundreds μm are formed on the substrate or in the interior of the substrate, and transportation, mixing, reaction, separation for is purification, etc. of a liquid sample or a liquid reaction product are carried out in the flow paths, so that from the pretreatment to the detection in the analysis will be completed in the same substrate.

### BACKGROUND ART

Firstly, biochips as one type of analytical chips will be described. Among biochips, typical are DNA chips having from hundreds to thousands of microspots of numerous DNA fragments immobilized on the substrate. DNA chips are reacted (hybridized) with DNA from human or animals to be examined for numerous DNA sequences to analyze sequence variation among individuals, gene expression in cells in different states and the like. The subsequent description will deal with DNA as a representative, though it also applies to RNA, proteins and sugar chains. Biochip fabrication is roughly classified on the basis of the method of immobilization of DNA on the substrate, as the photolithographic synthesis on a solid phase and as the array stamping of numerous kinds of pre-synthesized DNA to be tested for on the substrate. In either method, immobilized DNAs (hereinafter referred to as probes) are reacted with a mixture of DNA fragments (hereinafter referred to as DNA analytes). The DNA analytes are usually detected by preliminarily tagging them with fluorophor molecules and measuring the relative fluorescence intensity of each spot under excitation light with a fluorescent reader.

The fluorescence is weaker than the excitation light, and the maximum and minimum densities of DNA analytes differ by 1000 to 10000 times. Low density DNA analytes are difficult to detect accurately because of the noise such as the fluorescence emission or reflection from the substrate surface and dirt on it.

As approaches for higher ratios of fluorescence intensity to noise (S/N ratios), formation of a film with high affinity for DNA probes on an uneven substrate to increase fluorescence densities by allowing accurate spot formation (JP-A-2003-14744 (Mode of Carrying Out the Invention)) and formation of random fine scratches on the substrate surface by sandblasting to increase the surface areas of spots and thereby fluorescence densities by allowing accurate spot formation (JP-A-2003-107086 (Mode of Carrying Out the Invention)) were proposed. However, these approaches are disadvantageous in terms of production cost because they require formation of an uneven substrate surface which requires special materials or processing or washing steps. No substrate that itself improves S/N ratios, as in the present invention, has been proposed yet.

Use of glass sheets made of quartz glass (synthetic quartz glass, sometimes referred to as silica glass) or borosilicate glass as biochip substrates with low fluorescence noise (background fluorescence) has been known (JP-A-2003-14744 and JP-A-2003-107086). Because they are produced batchwise with precision surface polishing, their production cost is high enough to hamper the spread of biochips. On the other hand, soda lime silica glass sheets used as window panes, though inexpensively obtainable with excellent surface flatness and smoothness, have a problem that the background fluorescence from them is stronger than that from quartz glass and borosilicate glass.

Namely, no inexpensive biochip substrates have been proposed that give as low background fluorescence as quartz glass, do not require precision polishing when used as substrates or attain sufficient S/N ratios without formation of fine irregularities on the surface.

Likewise, with respect to microfluidics as one type of analytical chips, no inexpensive microfluidic substrate has been proposed that is capable of measuring fluorescence with high precision and sensitivity, of a trace amount of a liquid sample flowing in flow paths formed on the substrate or in the interior of the substrate. In this specification, biochips and microfluidics will be generally referred to as analytical chips.

The object of the present invention is to provide an inexpensive analytical chip glass substrate with little background fluorescence which enables accurate and sensitive measurements by enhancing the S/N ratio of each spot.

The present invention provides a analytical chip substrate which is a soda lime silica glass sheet containing at most 0.1 mass % of Fe, in terms of Fe₂O₃.

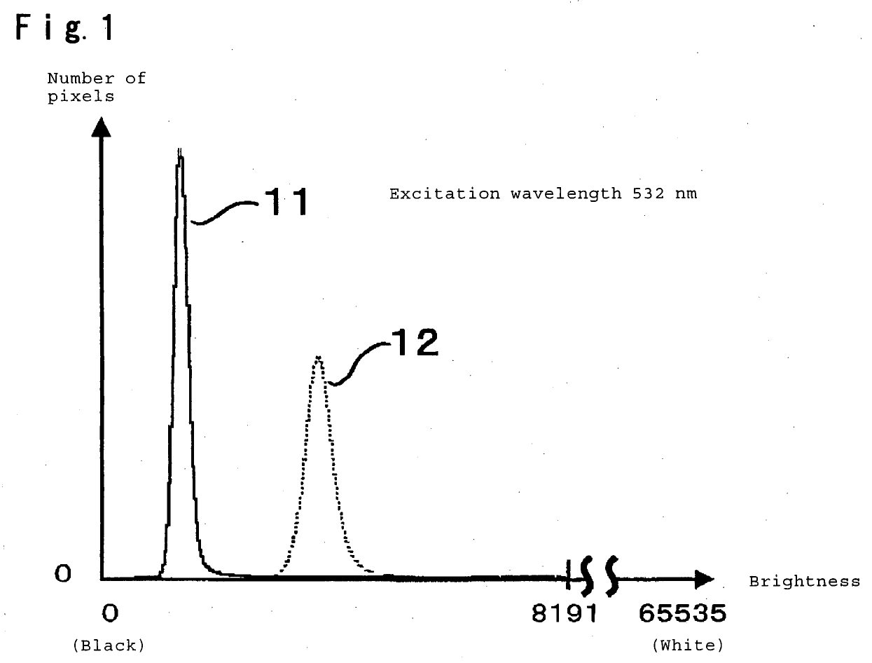

FIG. 1 shows background fluorescence measured at an excitation wavelength of 532 nm.

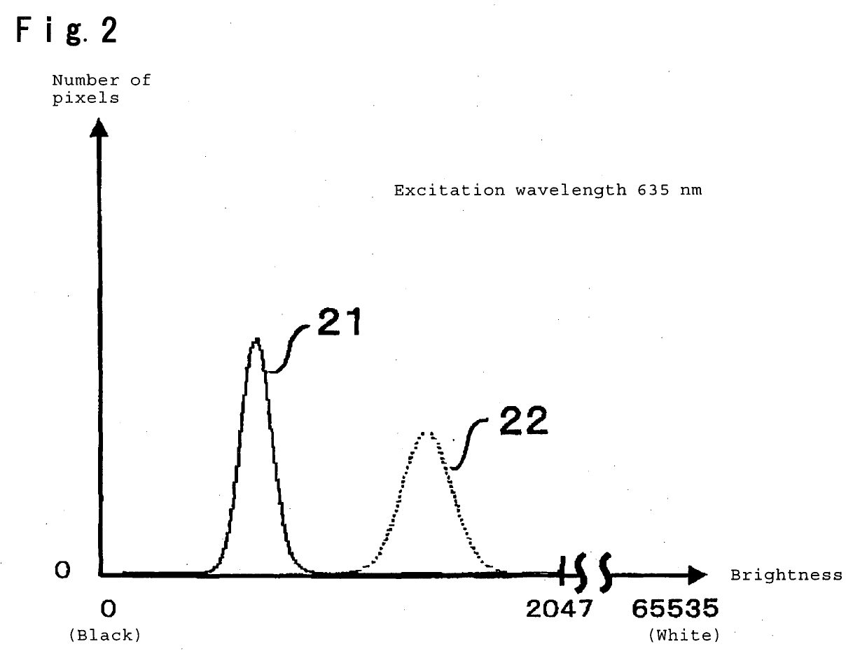

FIG. 2 shows background fluorescence measured at an excitation wavelength of 625 nm.

When the analytical chip glass substrate of the present invention is used as a biochip glass substrate, it gives off little background fluorescence. Therefore, the fluorescence intensities from DNA analytes become relatively high, and high S/N ratios can be attained. Further, because the glass substrate is made of soda lime silica glass, which can be produced easily from inexpensive ingredients as compared with quartz glass, it is advantageous in view of production cost. Because it can be produced by the float process stably with a flat and smooth surface without polishing or subsequent washing or drying, it is advantageous also in view of productivity. Therefore, it greatly contributes to popularization of diagnosis using biochips.

When the biochip glass substrate has a surface finish having high affinity for DNA probes on the surface which makes the front surface of a biochip, high S/N ratios can be attained, and it can make a biochip with good data reproducibility.

Thus, the substrate itself secures high S/N ratios over the entire surface, the resulting biochip can be used without special changes in the conventional biochip assay procedures and equipment and can measure precisely a wide range of DNA analytes from high density DNA analytes which tend to give off fluorescence with saturated intensities to low density DNA analytes which give off subtle fluorescence, while the excitation light required to produce fluorescent signals are kept at a fixed intensity.

Accordingly, it is possible to obtain more integrated biochips with higher densities by reducing the diameter of each sample spot and reduce the number of biochips to be used by increasing the information obtained from a single biochip. If a single assay can be done with one biochip, more reliable assay data of higher quality will be obtained because no calculations are necessary to correct variation in the data obtained from respective biochips.

Likewise, when the analytical chip glass substrate of the present invention is used as a microfluidic substrate, a trace amount of a liquid sample or the like flowing in the flow paths formed on the substrate or in the interior of the substrate can be measured accurately with high sensitivity. Accordingly, the flow paths can be designed to be finer, the limit for the analytical concentration can be lowered, and the quality and reliability of the measured data will be improved.

The analytical chip substrate of the present invention (hereinafter referred to as the present substrate) is a glass substrate used to immobilize a biological high-molecular-weight oligomer or to form flow paths for a trace amount of a liquid sample for analysis or the like, and is made of soda lime silica glass containing at most at most 0.1 mass % of Fe, in terms of Fe₂O₃.

The present inventors have found that the background fluorescence from soda lime silica glass containing at most 0.1 mass % of Fe, in terms of Fe₂O₃ is weak at excitation wavelengths of 532 nm and 635 nm, which are usually used in biochip assays. Also in microfluidics, the background fluorescence will be weak. The present substrate is preferably made of a soda lime silica glass containing at most 0.07 mass % of Fe in terms of Fe₂O₃, in particular at most 0.05 mass % of Fe in terms of Fe₂O₃.

Though there are no other compositional restrictions on the soda lime silica glass which constitutes the present substrate except for the Fe content as long as it can be manufactured by the float process, it preferably contains from 65 to 75 mass % of SiO₂ on an oxide basis, from 0 to 5 mass % of Al₂O₃, from 10 to 16 mass % of Na₂O, from 0 to 5 mass % of K₂O, from 5 to 15 mass % of CaO and from 0 to 7 mass % of MgO, more preferably 0.1 mass % of K₂O, less than 0.1 mass % of Cl and at least 1.5 mass % of Al₂O₃.

As to other ingredients not mentioned above, it may contain SrO, BaO, ZnO and ZrO₂ in an amount of, for example, at most 1 mass % each, in order to adjust the mechanical and thermal properties of the glass substrate or as impurities, Sb₂O₃, F and Cl in an amount of, for example, at most 0.5 mass % each as refining agents or impurities, and SnO₂ in an amount of, for example at most 0.5 mass % to adjust the degree of reduction of the glass or as an impurity.

It is preferred to produce the present substrate by the float process which cost-advantageously affords mass production of substrates with excellent smoothness and flatness, though there are no particular restrictions. It may be produced by other processes than the float process, preferably with precision polishing or the like, if necessary. The present substrate preferably has a surface roughness Ra of less than 100 nm because a surface finish such as silane coupling agent is applied easily to secure even hybridization, and the fluorescent signals from analytes can be read without changing the focus. The surface roughness Ra of the present substrate is more preferably less than 10 nm, in particular less than 1 nm.

In a case where the analytical chip is used as a biochip, it is preferred to treat the glass surface of the present substrate which makes the front surface of the biochip with a surface finish to introduce functional groups reactive with DNA probes to the glass surface, because DNA probes can bind to the surface of the glass substrate more firmly to make it possible to obtain higher S/N ratios and biochips with higher data reproducibility.

Likewise, in a case where the analytical chip is used as a microfluidic, it is preferred to treat the surface of the present substrate to be used for the flow paths with a surface finish having no affinity or reactivity with the liquid sample for analysis or the like flowing in the flow paths, so that it is thereby possible to prevent clogging of the flow paths with the liquid sample for analysis or the like, an excellent S/N ratio can be obtained, or reproducibility of data will be high.

The surface finish is preferably a silane coupling agent, though it is not particularly restricted as long as it has the above-mentioned function, for reasons, though not fully understood, which probably relate to the strengthening effect of a silane coupling agent on the bonding between the glass substrate and DNA probes and the presence of many sites reactive with a silane coupling agent on the surface of the soda lime glass which facilitates even surface finishing.

The silane coupling agent typically has a chemical structure RSiX₃ where R is an organic functional group, and X is a hydrolysable group reactive with an organic substance. The organic functional group R preferably has vinyl, glycidoxy, methacryl, amino, mercapto, aldehyde, epoxy, carboxyl, hydroxyl or the like, while X is preferably chlorine or an alkoxy group such as a methoxy group, an ethoxy group, a propoxy group, a butoxy group, a pentyloxy group or a hexyloxy group.

As an example of the silane coupling agent, Υ-aminopropyltriethoxysilane may be mentioned. A silane coupling solution prepared by diluting the silane coupling agent with an alcohol which is structurally equivalent to the hydrolysable group in it and then adding an appropriate amount of water to activate the hydrolysable group is preferably used.

The surface finish is preferably applied by coating, immersion or the like, though there are no particular restrictions, for example, by cloth-wiping or cleaning with an alkali or an organic solvent followed by drying, then immersion in a silane coupling solution for a predetermined period of time and drying to thermally cause coupling. The surface finish is applied to the glass substrate preferably in a thickness of from 1 nm to 100 nm, particularly from 2 nm to 50 nm, more particularly from 3 nm to 30 nm.

Now, the present invention will be described with reference to Examples.

Glass Substrates

A soda lime silica glass sheet (Asahi Glass Corporation) with a 1 mm thickness produced by the float process was used as the present substrate in this experiment. The present substrate was cut into a rectangle of 25 mm×76 mm, immersed in 10 mass % aqueous sodium hydroxide for 30 minutes and rinsed sufficiently with distilled water to give a test piece. The surface roughness Ra measured with a surface profiler (TALYSURF, manufactured by TAYLOR HOBSON) was about 0.6 nm.

As the comparative substrate, a commercial soda lime silica glass sheet (manufactured by Telechem, product name: SuperClean, about 25 nm×76 mm, thickness about 1 mm) was used and cleaned in the same manner as the present substrate. The surface roughness Ra measured in the same manner as the present substrate was about 5 nm.

The compositions of the present substrate and the comparative substrate were analyzed by an X-ray fluorescence analyzer (manufactured by Rigaku, product name: ZSX100e), and the results are shown in Table 1. The composition of the glass constituting the present substrate is not restricted to that in this Examples.

TABLE 1

| Detailed | Present substrate/ | Comparative |
|---|---|---|
| composition | mass % | substrate/mass % |
| SiO₂ | 74 | 73 |
| Al₂O₃ | 1.7 | 1.2 |
| Na₂O | 11 | 11 |
| K₂O | 0.026 | 0.26 |
| MgO | 4.4 | 4.1 |
| CaO | 9.0 | 9.5 |
| SrO | — | 0.011 |
| BaO | 0.049 | 0.061 |
| Fe₂O₃ | 0.048 | 0.14 |
| TiO₂ | 0.036 | 0.06 |
| SO₃ | 0.2 | 0.22 |
| Cl | 0.04 | 0.22 |
| ZrO₂ | 0.01 | 0.01 |
| MnO | — | 0.038 |

Evaluation Method

The reflection fluorescence from the test pieces was observed with a fluorometer (GenePix4000B manufactured by Axon) with the excitation light energy set at its maximum (power output 100%, energy 1000) at excitation wavelengths of 532 nm and 635 nm over about 25 mm×25 mm area in the center of the about 25 nm×76 mm rectangle. The observation results at excitation wavelengths of 532 nm and 635 nm were loaded onto the attached computer as monochrome TIFF images (16 bit) in a 65536-level gradation at a 1000×1000 pixel resolution.

Histogram analysis of the images was done using standard image processing software GIMP, while the 16-bit tone data were maintained. The histograms were obtained by graphically plotting brightness values ranging from black (brightness 0) to white (brightness 65535) as abscissa against the number of pixels at each brightness value in the images as ordinate. When the pixels have low brightnesses (closer to 0, i.e., black), or when a sharp peak appears at a low brightness value, a substrate is considered to be a preferable analytical chip (biochip) substrate giving little background fluorescence.

The results of the analysis are shown in FIG. 1 for the images obtained at an excitation wavelength of 532 nm and in FIG. 2 for the images obtained at an excitation wavelength of 635 nm. FIG. 1 and FIG. 2 show that lower brightness values and sharper peaks were obtained with the present substrate (11, 12) than with the comparative substrate, and that the background fluorescence was lower from the present substrate than from the comparative substrate. Thus, the present substrate is a better biochip substrate than the comparative substrate. The mean brightnesses, standard deviations and median brightnesses obtained from FIG. 1 and FIG. 2 are shown in table 2.

TABLE 2

| | Excitation wavelength | | Excitation wavelength | |
|---|---|---|---|---|
| | 532 nm | | 635 nm | |
| | Present | Comparative | Present | Comparative |
| | substrate | substrate | substrate | substrate |
| Mean | 1254.0 | 3680.0 | 539.2 | 1317.2 |
| brightness | | | | |
| Standard | 284.1 | 353.6 | 104.7 | 168.3 |
| deviation | | | | |
| Median | 1280.0 | 3584.0 | 512.0 | 1280.0 |
| brightness | | | | |

The present substrate with little background fluorescence from it allows measurement of the fluorescence from DNA analytes at high S/N ratios and makes it possible to obtain accurate data. Especially, it is expected that fluorescence from low density DNA analytes expressed at low levels can be analyzed precisely. The high S/N ratios allow formation of microspots and provision of highly integrated biochips. The present substrate having the above-mentioned excellent features is a glass substrate inexpensively obtainable by the float process and, therefore, greatly contributes to popularization of the use of biochips in genetic research and gene analysis.

Likewise, the present substrate can provide a microfluidic which makes accurate detection or analysis possible.

The entire disclosure of Japanese Patent Application No. 2004-289782 filed on Oct. 1, 2004 including specification, claims, drawings and summary is incorporated herein by reference in its entirety.

What is claimed is:

1. A analytical chip glass substrate which is a soda lime silica glass sheet containing at most 0.1 mass % of Fe, in terms of Fe₂O₃.

2. The analytical chip glass substrate according to claim 1, wherein the soda lime silica glass sheet contains, in addition of Fe, from 65 to 75 mass % of SiO₂ on an oxide basis, from 0 to 5 mass % of Al₂O₃, from 10 to 16 mass % of Na₂O, from 0 to 5 mass % of K₂O, from 5 to 15 mass % of CaO and from 0 to 7 mass % of MgO.

3. The analytical chip glass substrate according to claim 1, which has a surface finish on the surface which makes the front surface of a analytical chip.

4. The analytical chip glass substrate according to claim 1, wherein the surface finish is a silane coupling agent.

5. The analytical chip glass substrate according to claim 1, wherein the soda lime silica glass sheet is prepared by the float process.

6. A analytical chip which uses the analytical chip glass substrate as defined in claim 1.
